(19) United States
(12) Patent Application Publication
(10) Pub. No.: US 2022/0379297 A1
(43) Pub. Date: Dec. 1, 2022

(54) MODULAR SAMPLE PROCESSING DEVICE

(71) Applicant: Waterford Institute of Technology, Waterford (IE)

(72) Inventors: Lee Coffey, Waterford (IE); Tríona Marie Dooley-Cullinane, Waterford (IE)

(21) Appl. No.: 17/594,964

(22) PCT Filed: May 29, 2020
(86) PCT No.: PCT/EP2020/065079

§ 371 Date: Nov. 4, 2021

(30) Foreign Application Priority Data
May 29, 2019 (GB) 1907537.3

(51) Int. Cl. B01L 3/00

(52) U.S. Cl. CPC B01L 3/502; B01L 2200/028; B01L 2400/0478; B01L 2300/0672; B01L 2300/028; B01L 2300/042; B01L 2300/0832; B01L 2400/0683; B01L 2400/0644

(57) ABSTRACT

Broadly speaking, embodiments of the present techniques provide a modular sample processing device which allows a user to perform any number of biological processes within a single device, in the order the user requires. The device is customisable—a user may select two or more modules and connect them in series to form the device in which the biological processing takes place. Advantageously, this may enable a user to perform multiple processes within a single device and potentially outside of a laboratory (e.g. during field work) or outside of sterile/aseptic environments. Furthermore, the device is a hand-held device, which means the device is compact and easy to transport and use for field work.

The present techniques generally relate to a modular sample processing device for performing different processes on a biological sample.

Typically, biological samples are processed using multiple different machines, using different pieces of equipment, and/or using different processes. This usually requires samples being taken from one machine or piece of equipment, or from one area in a laboratory to another area. However, if the biological sample needs to be kept in a sterile or aseptic environment, the movement during this processing may cause the biological sample to become contaminated unless care is taken for all equipment and areas within a laboratory to be kept sterile/aseptic.

Background information can be found in the following patent literature. US2005/031493 discloses a large desktop/benchtop apparatus for subjecting a liquid sample to one or more chemical processing operations, the apparatus having an interconnect between chambers that provides fluid communication between the chamber and where liquid flows through the device by controlling the volume of liquid in each chamber by a plunger or an actuator. US2011/287472 discloses a system of freely combinable functional units that can be connected together to form a sample-processing system, where a flow-regulating connection unit, that is preferably a vacuum unit, is used to control the flow of liquid. WO2011/119711 discloses a purification cartridge having a reaction chamber and a molecular capture chamber. US2010/012589 discloses a unit for preparing a sample for the microbiological analysis of a predetermined volume of liquid, the unit having a collection module for liquids and a filter module for those liquids. U.S. Pat. No. 4,215,198 discloses a stackable disposable filtration-incubation unit for testing the sterility of filterable liquids. However, these documents disclose devices that are complex from a mechanical point of view (e.g. have complex components to facilitate the flow of liquid), and complex from a manufacturing point of view (which increases the cost of the device and makes it less desirable). In many biology and chemistry laboratories, cheap, single-use devices and components are desirable, as these reduce the need to carefully clean, decontaminate and sterilise the devices and components for re-use. In contrast, these documents disclose devices that are complex and so are likely to be expensive and not suitable for single-use, and may not be easily used outside a laboratory setting (e.g. in the field/during field work).

The present applicant has identified the need for an improved device that enables processing of biological samples.

In a first approach of the present techniques, there is provided a hand-held modular device for processing a biological sample comprising: at least two modules connected together in series for performing specific biological processes, wherein after the biological process performed by a module is complete, an output from the module is input into an adjacent module in the series.

Preferred embodiments are set out in the appended dependent claims.

Implementations of the present techniques will now be described, by way of example only, with reference to the accompanying drawings, in which:

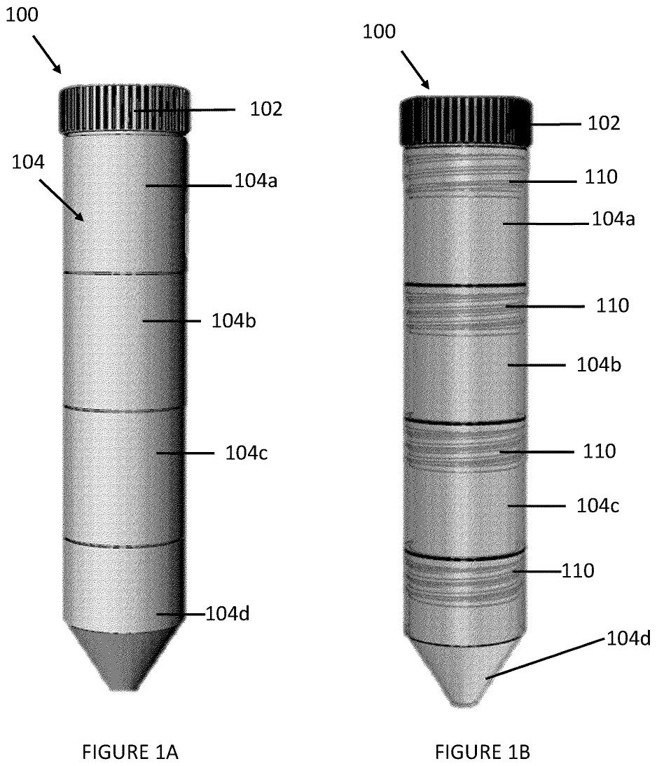

FIG. 1A shows a side view of an example modular sample processing device;

FIG. 1B shows the modular device of FIG. 1A with internal details visible;

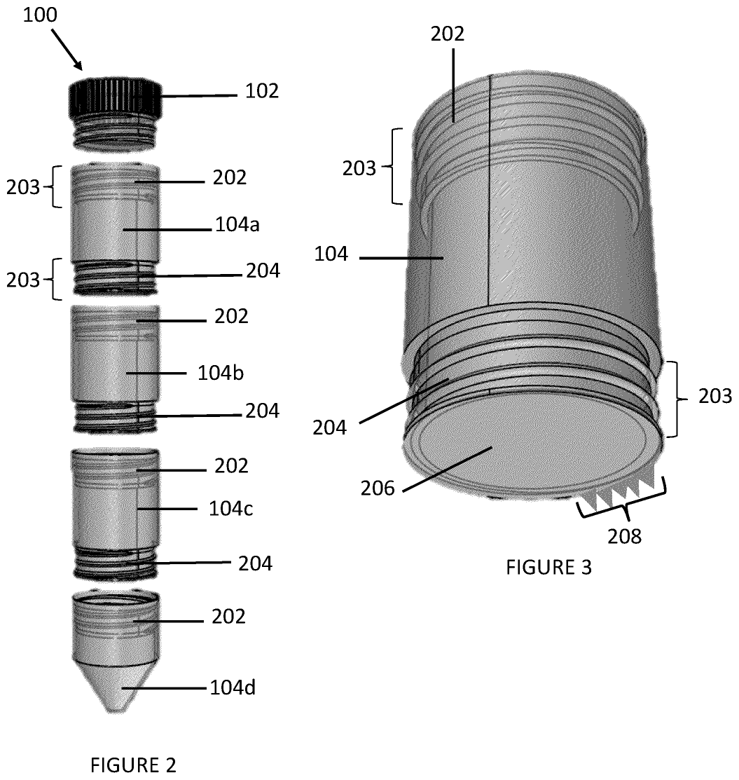

FIG. 2 shows an exploded view of the modular device of FIG. 1A;

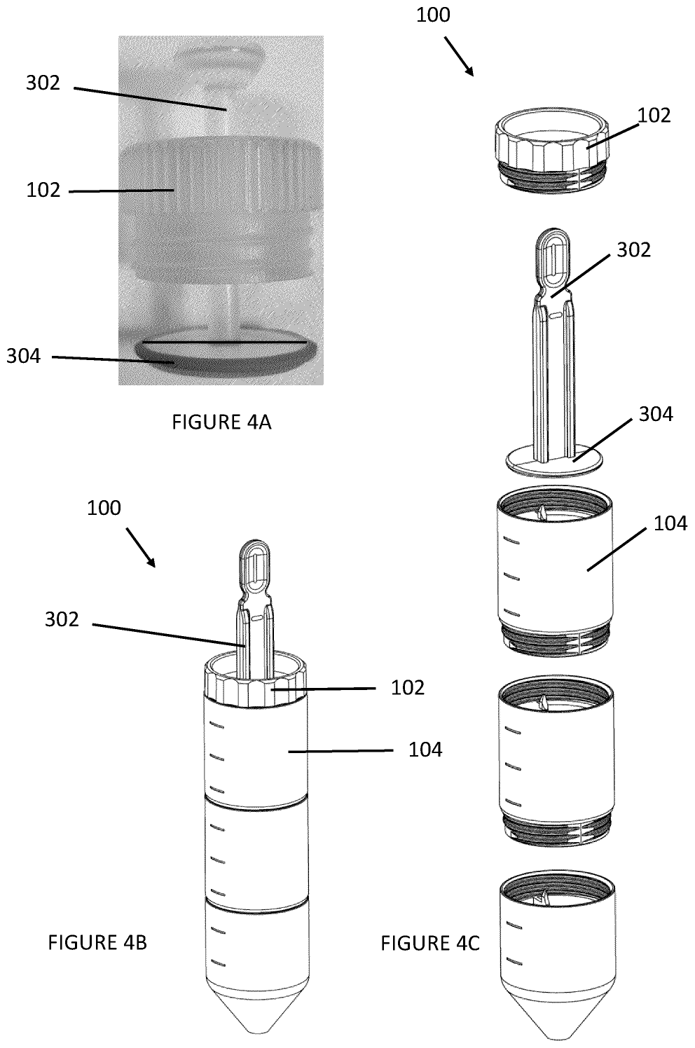

FIG. 3 shows an example of a module of the modular device of FIG. 1A;

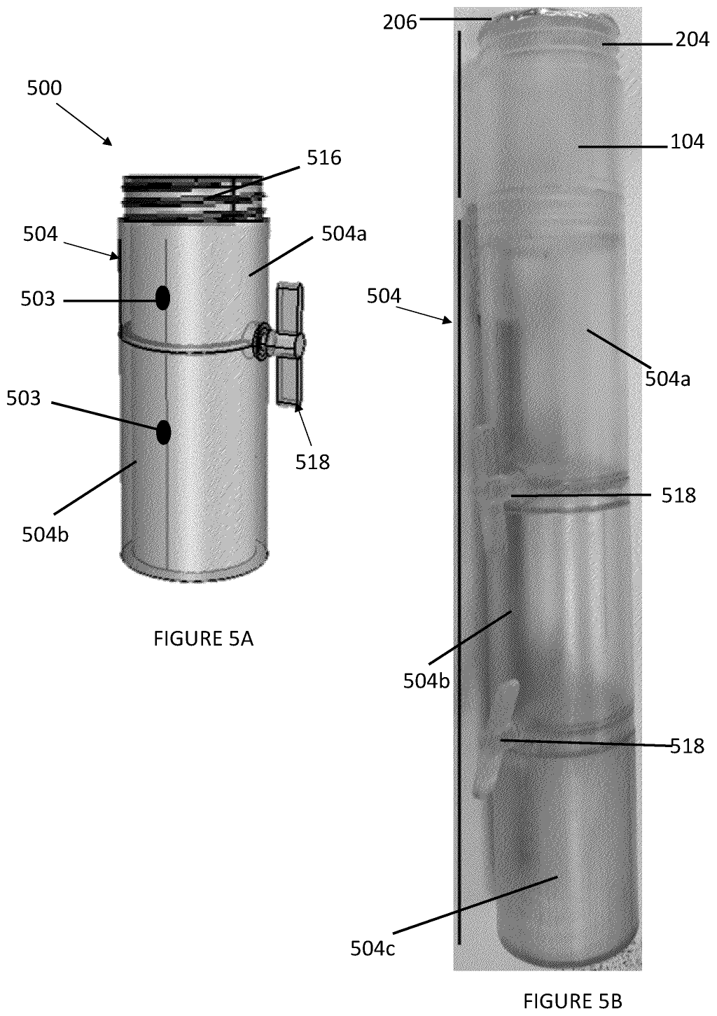

FIG. 4A shows an example of a lid of the modular device of FIG. 1A;

FIGS. 4B and 4C show, respectively, a perspective view and an exploded view of the modular device of FIG. 1A with the lid of FIG. 4A;

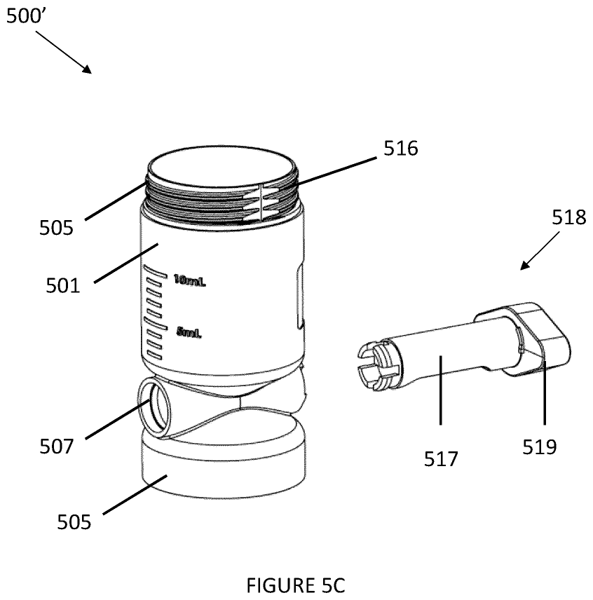

FIG. 5A shows another example of a module of the modular device of FIG. 1A;

FIG. 5B shows the module of FIG. 5A coupled to a module of FIG. 3;

FIG. 5C shows another example of a module of the modular device of FIG. 1A;

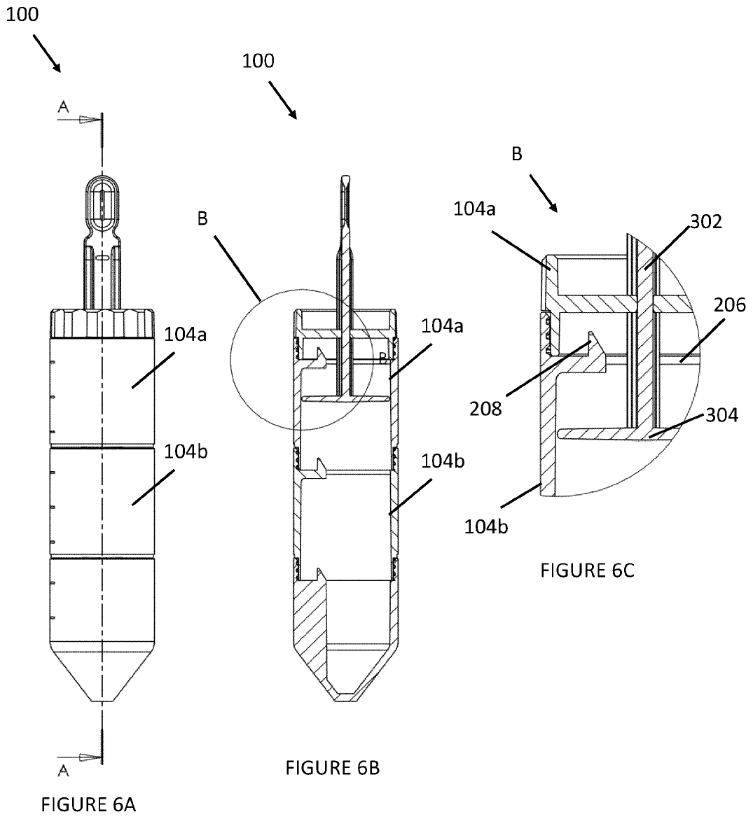

FIGS. 6A and 6B show, respectively, a side view and a cross-sectional view of the modular device of FIG. 1A having a lid; and

FIG. 6C shows a zoomed-in view of a cutting mechanism of the modular device.

Broadly speaking, embodiments of the present techniques provide a modular sample processing device which allows a user to perform any number of biological processes within a single device, in the order the user requires. The device is customisable—a user may select two or more modules and connect them in series to form the device in which the biological processing takes place. Advantageously, this may enable a user to perform multiple processes within a single device and potentially outside of a laboratory (e.g. during field work) or outside of sterile/aseptic environments. Furthermore, the device is a hand-held device, which means the device is compact and easy to transport and use for field work.

FIG. 1A shows a side view of an example modular sample processing device 100 for processing a biological sample. The modular device comprises: at least two modules 104 connected together in series for performing specific biological processes, wherein after the biological process performed by a module is complete, an output from the module is input into an adjacent module in the series.

The modular device 100 may comprise a consecutive series of modules 104, which may be used for processing a biological sample. The modules 104 are arranged consecutively to allow the biological sample to flow from a first module 104, to a second module 104 and, if required, any number of further modules. In this way, the modular device 100 may provide a compact workflow where each module 104 has a discrete function that is dependent upon the output of the previous module 104.

In the example shown in FIG. 1A, the device 100 comprises four modules 104a to 104d. Module 104a is connected to module 104b, module 104b is connected to module 104c, and module 104c is connected to 104d. This arrangement may enable four biological processes to be performed. One or more of the modules may perform the same biological process. Alternatively, all of modules may perform different biological processes. Each module of the at least two modules may be used to/function to perform a different biological process. It will be understood that the number of modules shown in FIG. 1A is merely exemplary and generally speaking, the device 100 may comprise two or more modules 104. Module 104d in FIG. 1A has a conical shape—this shape may be suitable for performing centrifugation. It will be understood that the device 100 may not comprise a module having a conical shape.

One module of the device 100 is the first module of the device, which is used to perform the first biological process and to which another module is connected in series. In FIG. 1A, module 104a is the first module. The first module 104a may comprise an open end to enable a sample to be added to the first module. A lid 102 may be attachable to the open end of the first module 104a. The lid 102 may be any one of: a screw cap, a flip-cap or a plug, a foil layer, aluminium foil, Polyvinyl chloride film, polyethylene wrap or a thermoplastic flexible plastic film. The user of device 100 may provide an alternative to lid 102 in the form of a layer of material provided over the opening of the first module 104a. The layer of material may be, for example, a layer of aluminium foil, Polyvinyl chloride film, polyethylene wrap or a thermoplastic flexible plastic film.

FIG. 4A shows an example of a lid 102 for use with the modular device 100. Dependent upon the experimental design, a user of device 100 may desire the lid 102 to be a screw cap, a flip-cap, a plug or a plunger. The lid 102 may further comprise a plunger arm 302 and a plunger base 304. This may allow sedimentation of a solid sample. Alternatively, the lid 102 comprising a plunger arm 302 and a plunger base 304, may be used in combination with a film layer 206 comprising a filtering mechanism, to provide a back pressure to push sample through a said filtering mechanism.

In experiments using the modular device 100, it is important to prevent leaking of the samples, particularly if the samples are hazardous or toxic to the user. Thus, the skilled person would understand that the lid 102 comprising a plunger arm 302 and a plunger base 304 may be made from a suitable rubber material to provide a natural seal with the lid 102 being formed from a plastic cap to prevent leaking.

The skilled person would further understand that an O-ring or similar seal may be a desired addition to the lid 102, to prevent leaking.

In some cases, for example where a processing experiment requires evaporation of a solvent, for example ethanol, the end-user may forgo the addition of the lid 102.

FIGS. 4B and 4C show, respectively, a perspective view and an exploded view of the modular device of FIG. 1A with the lid of FIG. 4A. As noted above, the lid 102 may comprise a plunger arm 302 and a plunger base 304 of a plunger. Alternatively, the lid 102 may contain an opening (not visible) to allow the plunger arm 302 of the plunger to pass through the lid 102. The opening on lid 102 may be shaped such that the plunger arm 302 is a tight fit within the opening, thereby preventing contamination of the sample within the module 104 from the external environment. Additionally or alternatively, the plunger base 304 may form a seal with the internal surface of the module 104.

FIG. 1B shows the modular device 100 of FIG. 1A with internal details visible, and FIG. 2 shows an exploded view of the modular device of FIG. 1A. Each module 104 comprises at least one mating portion 203, and the mating portion 203 comprises a connection mechanism 110 for connecting the module to another module. In FIG. 1B, the same connection mechanism 110 is used to connect the lid 102 to the first module 104a as to connect modules 104 to each other. However, it will be understood that a different connection mechanism may be used to connect the lid 102 to the first module 104a, depending on the specific form of the lid 102. In the example shown in FIGS. 1B and 2, the connection mechanism 110 of one module may be one of a thread 204 or a groove 202, and may be connectable to the other of a thread 204 or a groove 202 of another module. In other words, the thread of one module may connect to the groove of another module. The or each connection mechanism 110 may comprise a screw mechanism to connect together two modules.

Each module 104 may perform a discrete role or single step within a compact workflow. During processing of a biological sample, for example, during a purification process, it may be important to keep the contents of each module 104 contained within the module before it progresses into the next module 104. It may also be important to keep a sample contained within the module 104 sterile to prevent contamination from the surrounding environment. In such cases, a seal may be used to provide a barrier to prevent the contents of one module 104 flowing into the consecutive module 104.

FIG. 3 shows an example of a module 104 of the modular device 100 of FIG. 1A. The mating portion 203 of each module may comprise a seal 206. The seal 206 may comprise a non-permeable membrane layer. The first module 104a may not comprise a seal 206. Alternatively, the first module 104a may comprise a seal to keep the module sterile/aseptic before use, and which must be removed in order to add a sample to the module—in this case, the lid 102 then replaces the seal to close the module 104a. The seal 206 prevents the sample in one module 104 from flowing or moving into an adjacent module 104 until the biological process performed by a module has been completed. The seal may therefore be made of a non-permeable material.

In some cases, each mating portion 203 of each module may comprise a seal 206, regardless of whether the module is coupled to a lid or another module.

In some cases, each mating portion 203 of each module may comprise a seal 206. Alternatively, each module 104 may comprise an open end and a sealed end. The open end of a module 104 may mate with the sealed end of another module 104. The sealed end/seal 206 may be formed of a film layer, which may be, for example, a layer of aluminium foil, Polyvinyl chloride film, polyethylene wrap or a thermoplastic flexible plastic film.

The seal 206 may further comprise a filtering mechanism to allow the output of one module 104 to be filtered as it progresses into the adjacent module 104. The filtering mechanism may be provided by forming the seal 206 from a permeable or semi-permeable material. The skilled person would understand that any suitably sized filter may be used depending on the experimental requirements. For example, the pores of the permeable/semi-permeable material may range from 0.1 to 10 μm. The permeable or semi-permeable material may be, for example, cellulose, mixed cellulose esters, polycarbonate, polyesthersufone, polysufone, PTFE, PVDF, silver, nylon, polypropylene, or alumina nitrocellulose.

The mating portion 203 of each module 104 may comprise a cutting mechanism for breaking the seal 206 of an adjacent module. That is, in order for the output of one module to be input into an adjacent module, two seals need to be broken. Breaking the seal may include semi-scoring or otherwise partially cutting through each seal so that transfer between the modules may occur but each seal is not detached from its respective module. In this way, the seal remains at least partially attached to the module and is not free or loose therein. The cutting mechanism may comprise any one or more of: a sharp edge, a sharp tooth, multiple sharp teeth, a serrated edge, a piercing element, a piercing and cutting element, a slicing element, and a scoring element. In the example shown in FIG. 3, the cutting mechanism comprises a series of teeth 208. The cutting mechanism may be part of the connection mechanism 110.

The cutting mechanism may be activated by rotating one module relative to an adjacent module. For example, if two modules 104 are connected by screwing the modules together, twisting/turning one module relative to the other by some amount may screw the two modules together, and twisting/turning one module by a further amount may activate the cutting mechanism. For example, twisting one module by a quarter or a half rotation may connect the two modules together, and twisting one module by a further quarter or half rotation may cause the cutting mechanisms of each module to engage with the seal of the other module. In this way, once two modules are connected together and the sample is inside the device 100, the sample can be moved from one module to another simply by performing an action on or to the device 100. Advantageously, this means the sample remains in the device 100 and is not exposed to contaminants between performing different processes. Furthermore, the sample can remain in a module (and in a sealed environment) until the next process is to be performed, without risk of contamination. Preferably therefore, the cutting mechanism may be activated only after the biological process performed by a module is complete.

As mentioned above, each mating portion 203 of a module may comprise a seal, including any module that is coupled to or couplable to a lid. This ensures that even if the lid is removed from a module, the contents of the module remain sterile and unexposed to the external environment due to the presence of the seal. In this case, a seal of the module may be broken either by mating the module to another module (as described above), or by a scoring or cutting mechanism provided within each lid. The scoring or cutting mechanism within each lid may operate in the same way as the cutting mechanism of each module, i.e. screwing on a lid to a module secures the lid to the module, but turning the lid further to tighten the lid engages the cutting mechanism of the lid with the seal on the module. The cutting mechanism of the lid may comprise any one or more of: a sharp edge, a sharp tooth, multiple sharp teeth, a serrated edge, a piercing element, a piercing and cutting element, a slicing element, and a scoring element. The cutting mechanism may be part of the fastening mechanism of the lid.

FIGS. 6A and 6B show, respectively, a side view and a cross-sectional view of the modular device of FIG. 1A having a lid (of the type shown in FIGS. 4A to 4C), and FIG. 6C shows a zoomed-in view of a cutting mechanism of a module of the modular device. As shown in FIGS. 6B and 6C, each module 104 may comprise a seal 206. The seal 206 may comprise a non-permeable membrane layer. The last module 104c may not comprise a seal 206. The seal 206 prevents the sample in one module 104 from flowing or moving into an adjacent module 104 until the biological process performed by a module has been completed. The seal may therefore be made of a non-permeable material.

The mating portion 203 of each module 104 may comprise a cutting mechanism for breaking the seal 206 of an adjacent module. That is, in order for the output of one module (e.g. module 104a) to be input into an adjacent module (e.g. module 104b), a seal 206 needs to be broken. The cutting mechanism may comprise any one or more of: a sharp edge, a sharp tooth, multiple sharp teeth, a serrated edge, a piercing element, a piercing and cutting element, a slicing element, and a scoring element. In the example shown in FIGS. 6B and 6C, the cutting mechanism comprises a sharp tooth 208. The cutting mechanism of module 104b may break the seal 206 of module 104a, using any of the techniques described above with respect to FIG. 3.

Each module 104 of device 100 may be adapted to be used to perform any one of: sample stabilisation, sample storage, enrichment, selective enrichment, filtration, centrifugation, DNA extraction lysis, DNA extraction washing, aerobic, anaerobic enrichment/culturing, chromatography, buffer exchange, mammalian cell culturing (both adherent and non-adherent cell lines), phage isolation/enrichment, bacterial cell culturing, sample dilution, or processing environmental samples such as, but not limited to, soil or water. For example, for anaerobic enrichment/culturing the module may comprise an oxygen scavenger to remove oxygen. It will be understood this is a non-exhaustive and non-limiting list of example biological processes that may be performed by each module 104.

A size of the device 100 and of each module 104 may be compatible with laboratory equipment. This may enable the whole device 100 to be used in standard laboratory equipment, such as a centrifuge, without needing to extract a sample. This is advantageous because the sample may remain in the device 100 while the device is used in other equipment. The modular device 100 may be designed to fit into any laboratory equipment with capacity for a tube with a volume of, for example, up to 1 ml, up to 10 ml, up to 50 ml, up to 100 ml, up to 150 ml, up to 200 ml, up to 250 ml. Such laboratory equipment may include, centrifuge, a rack, shaker, rotor wheel, incubator, shaker, water bath, vortex mixer . . .

The modular device 100 may be used for the processing of biological samples, such as bacteria or mammalian cell cultures, where aseptic technique is crucial to experimental success. Therefore, the components of modular device 100 may be formed from Polypropylene which has resistance to temperatures up to 135° C. and may be auto-claved, meaning the inner cavity of device 100 should remain sterile. The skilled person would understand that any suitable method for sterilisation could be used, for example, electron beam or gamma irradiation, steam autoclaving at a suitable temperature or Ethylene Oxide gas. The components of the modular device 100 may also be formed from one of, polypropylene, polyethene, polybutylene terephthalate, polyester, polycarbonate or polysulfone.

FIG. 5A shows another example of a module of the modular device of FIG. 1A, and FIG. 5B shows the module of FIG. 5A coupled to a module of FIG. 3.

The module 500 is a liquid dilution module, and comprises: at least two chambers 504 connected together and arranged to contain liquid (not shown); and a liquid transfer mechanism 518 provided between adjacent chambers and arranged to transfer a controlled volume of liquid from one chamber to an adjacent chamber.

The module 500 may be provided as a pre-formed device, such that the at least two chambers 504 are already connected together. In this case, the at least two chambers may be fixedly connected together, and a user may not be able to separate individual chambers 504 from the device without damaging the module 500. For example, the at least two chambers may be connected together by any or more of: heat sealing, an adhesive, and a UV-cured adhesive. It will be understood that this is a non-exhaustive list of example mechanisms for fixedly connecting together the chambers.

Alternatively, the module 500 may be provided as a kit comprising two or more chambers and one or more liquid transfer mechanisms, which a user may be able to assembly as they require. In this case, each chamber 504 may comprise at least one fastening mechanism for releasable connection of the chamber to at least one other chamber. The fastening mechanism may be or comprise a screw thread or clipping mechanism. This may enable a user to connect together as many chambers as they require, according to the number of serial dilutions they need to perform.

Chambers 504a and 504b are adjacent to each other and are connected together. Liquids may be provided in both chambers. For example, a stock solution may be provided in chamber 504a. Chamber 504b may contain a diluent. The liquid transfer mechanism 518 provided between chambers 504a and 504b may transfer a controlled volume of the stock solution in chamber 504a to the diluent in chamber 504b. For example, the liquid transfer mechanism 518 may transfer 1 ml of stock solution into 9 ml of diluent. As a result, chamber 504b contains a solution which is ten times less concentrated than the stock solution in chamber 504a. If further dilutions are required, one or more further modules of this type may be added to device 100. It will be appreciated that chamber 504a may initially contain only a diluent and a sample may be added to chamber 504a to provide a stock solution which is less concentrated than the sample (e.g. ten times less concentrated using 1 ml of sample to 9 ml of diluent).

To enable mating with a module 104 of the modular device 100, chamber 504a may comprise a screw thread 516 to allow mating with complimentary grooves 202 of a module 104.

The module 500 may comprise at least one sample aperture 503 for adding liquid to the device or removing liquid from the module. The module 500 may comprise a single sample aperture 503 on the chamber corresponding to the final dilution in the series (which in the example of FIG. 5A is chamber 504b). This may enable some or all of the liquid in chamber 504b to be extracted for further processing/use. Additionally or alternatively, each chamber 504 may comprise a sample aperture 503 to enable liquid to be added to or extracted from the module 500 (i.e. from each chamber 504). The sample aperture 503 may enable liquid to be poured out of the chamber 504, or may enable liquid to be extracted from the chamber 504 using a pipette, for example. The sample aperture 503 may be of any suitable diameter to allow, for example, a pipette tip of a P2, P10, P100, P1000, P5000, a 10 ml serological pipette to enter.

To prevent contamination or liquid leakage, and ensure aseptic technique and the sterility of the samples within the chambers is maintained, the or each sample aperture 503 may comprise a seal (not shown) for covering the sample aperture. The seal may be a removable seal, such as a removable film. The seal may be resealable to allow repeated access to the sample aperture 503. The seal may be a pierceable seal. The sampling aperture 503 may be sealed using a film such as any one of the following: Polyvinyl chloride film, polyethylene wrap, cellophane, tape, acetate, or a thermoplastic flexible plastic film. Alternatively, the sampling aperture 503 may be sealed using a bung, plug, stopper or cork, any of which may be formed from a suitable material such as hardened rubber, polypropylene or natural cork. It will be understood that these are non-limiting and non-exhaustive examples of seals for the sampling aperture 503. The seal may be broken by the end-user to allow a sample to be removed. When the seal is broken, the end-user should use aseptic technique or conduct the experiment in a biological safety cabinet if sterility is still required.

FIG. 5B shows the module 500 of FIG. 5A integrated into the modular device of FIG. 1A.

In the example device shown in FIG. 5B, a module 104 is connected to a liquid dilution module 500 which comprises three chambers 504a-c. Chambers 504a and 504b are adjacent to each other and are connected together, and chambers 504b and 504c are adjacent to each other and are connected together. This arrangement may enable two dilutions of a sample to be performed. A stock solution may be provided in chamber 504a. Chambers 504b and 504c may contain a diluent. The liquid transfer mechanism 518 provided between chambers 504a and 504b may transfer a controlled volume of the stock solution in chamber 104a to the diluent in chamber 504b. For example, the liquid transfer mechanism 518 may transfer 1 ml of stock solution into 9 ml of diluent. As a result, chamber 504b contains a solution which is ten times less concentrated than the stock solution in chamber 504a. If further dilutions are required, the solution in chamber 504b becomes the new ‘stock solution’. Thus, the liquid transfer mechanism 518 provided between chambers 504b and 504c may transfer a controlled volume of the new stock solution in chamber 504b to the diluent of chamber 504c. For example, the liquid transfer mechanism 518 may transfer 1 ml of the solution in chamber 104b into 9 ml of diluent in chamber 504c. As a result, chamber 504c contains a solution which is ten times less concentrated than the stock solution in chamber 504b, and 100 times less concentrated than the (original) stock solution in chamber 504a. In other words, two dilution steps have taken place and the original stock solution may be an undiluted or a diluted solution. Alternatively, chamber 504a may contain only a diluent and a sample may be added to chamber 504a to provide a stock solution, i.e. a solution which is less concentrated than the original sample (e.g. ten times less concentrated using 1 ml of sample to 9 ml of diluent). The diluted sample solution in chamber 504a may then be diluted twice using chambers 504b, 504c more as explained above. It will be understood that the or each liquid transfer mechanism 518 may be able to transfer any predetermined volume of liquid from one chamber to another. Similarly, each chamber 504 may contain any volume of diluent as required for the specific dilution being performed.

FIG. 5C shows another example of a module 500′ of the modular device of FIG. 1A. The module 500′ is a liquid dilution module, and comprises a liquid containing portion 501 and a liquid transfer mechanism 518 to transfer a controlled volume of liquid from the liquid containing portion 501 of the module to an adjacent module of the modular device.

Liquid may be provided in the liquid containing portion 501 of the module 500′. For example, a stock solution may be provided in liquid containing portion 501. The next, adjacent module of the modular device may contain a diluent. The liquid transfer mechanism 518 may transfer a controlled volume of the stock solution in liquid containing portion 501 to the diluent in the adjacent module. For example, the liquid transfer mechanism 518 may transfer 1 ml of stock solution into 9 ml of diluent. As a result, the adjacent module will contain a solution which is ten times less concentrated than the stock solution in liquid containing portion 501. If further dilutions are required, one or more further modules 500′ of this type may be added to device 100. It will be appreciated that liquid containing portion 501 may initially contain only a diluent and a sample may be added to liquid containing portion 501 to provide a stock solution which is less concentrated than the sample (e.g. ten times less concentrated using 1 ml of sample to 9 ml of diluent).

To enable mating with at least one other module 104 of the modular device 100, module 500′ comprises a mating portion 505, which may comprise a screw thread 516 to allow mating with complimentary grooves 202 of a module 104. As shown, module 500′ comprises two mating portions 505, which may each couple to another module 104 or may couple to a cap 102.

The module 500′ may comprise at least one sample aperture (not shown) for adding liquid to the device or removing liquid from the module, as described above with respect to FIGS. 5A and 5B.

The at least one mating portion 505 of the module 500′ may comprise at least one seal (not shown) to keep the module 500′ sterile/aseptic before use, and which must be removed in order for liquid to be transferred from one module to another. The seal may also prevent liquid in one module from flowing or moving into an adjacent module until the liquid transfer mechanism is activated/used. The seal may therefore comprise or be made of a non-permeable membrane layer. Each mating portion 505 of each module 500′ may comprise a seal. Alternatively, each module 500′ may comprise an open end and a sealed end. The open end of a module 500′ may mate with the sealed end of another module. The sealed end/seal may be formed of a film layer which may be, for example, a layer of aluminium foil, Polyvinyl chloride film, polyethylene wrap or a thermoplastic flexible plastic film.

Each liquid transfer mechanism 518 of the module 500′ may comprise a rotatable container 517 in a housing 507 of a module, and a handle 519, coupled to one end of the rotatable container 517, which extends outside of the device 100/module 500′ for rotating the rotatable container 517. The rotatable container 517 is depicted as being substantially cylindrical, but it will be understood that the container 517 may have any suitable shape or form. The or each rotatable container comprises an aperture that enables liquid to flow in to and out of the rotatable container 517.

The rotatable container 517 may be rotatable by a user of device 100 by operating the handle 519. The handle 519 may take any suitable form. The rotatable container may be rotated between at least: a first position in which the aperture of the rotatable container 517 aligns with a first aperture in the module 500′; and a second position in which the aperture of the rotatable container 517 aligns with a second aperture in the module 500′, wherein in the first position, liquid from the module 500′ fills the rotatable container 517, and in the second position, liquid from the rotatable container 517 is transferred to the adjacent module in the device 100. As noted above, module 500′ comprises a liquid containing portion 501 and at least one mating portion 505. The first aperture of the module 500′ may be within the liquid containing portion 501, and the second aperture of the module 500′ may be within one of the mating portions 505. The liquid transfer mechanism 518 may be provided in a housing 507 located between the liquid containing portion 501 and a mating portion 505 of each module 500′. Thus, the rotatable container 517 transfers liquid from the liquid containing portion 501 to a mating portion 505 that is connected to another module, and thus, liquid is transferred to this adjacent module.

The rotatable container 517 may also be rotated to a third position in which the aperture of the rotatable container 517 is closed, i.e. is not aligned with any apertures whereby liquid flow is prevented. Preferably, the rotatable container is only able to rotate in one direction or by a predefined amount, so that liquid may only be transferred in one direction to perform the dilution.

The chambers 504 of the module 500, or liquid containing portion 501 of module 500′, may be pre-filled with a diluent. The diluent may be a sterile diluent. The diluent may be, for example, sterile distilled water, or a Tris-HCl, sodium acetate, peptone buffer/phosphate buffer. The sterile diluent may be a liquid growth media, for example, a lysogeny broth (LB), Dulbecco's Modified Eagle Medium, minimal essential media, Dey-Engley Neutralizing Broth, or a phage buffer.

The module 500, 500′ may be arranged to perform one or more dilutions according to a predetermined dilution factor, such as, for example, 10-1, 10-2, 10-3, 10-4, 10-4, 10-5, 10-6, 10-7, 10-8, 10-9, 5-1, 2-1, and 3-1. The predetermined volume of (sterile) diluent required for the dilution may be, for example, 1 ml, 5 ml, 10 ml, 15 ml, 20 ml, 25 ml, 30 ml, 40 ml, 50 ml, 100 ml.

The module 500, 500′ may be able to dilute any type of liquid sample, such as, for example a biological sample, a chemical sample, and an environmental sample. Serial dilutions are often required in biology to accurately create highly diluted solutions as well as solutions for experiments. They may also be used to reduce the concentration of organisms or cells contained within a sample. In such cases, aseptic technique is required to prevent contamination of a sample. The module 500, 500′ may be used for the serial dilution of an input sample, under aseptic conditions.

Those skilled in the art will appreciate that while the foregoing has described what is considered to be the best mode and where appropriate other modes of performing present techniques, the present techniques should not be limited to the specific configurations and methods disclosed in this description of the preferred embodiment. Those skilled in the art will recognise that present techniques have a broad range of applications, and that the embodiments may take a wide range of modifications without departing from any inventive concept as defined in the appended claims.

1. A hand-held modular device for processing a biological sample comprising:
at least two modules connected together in series for performing specific biological processes, wherein after the biological process performed by a module is complete, an output from the module is input into an adjacent module in the series.

2. The device as claimed in claim 1 wherein each module of the at least two modules is for performing a different biological process.

3. The device as claimed in claim 1 wherein each module comprises at least one mating portion, and the mating portion comprises a connection mechanism for connecting the module to another module.

4. The device as claimed in claim 3 wherein the connection mechanism of one module is one of a thread or a groove, and is connectable to the other of a thread or a groove of another module.

5. The device as claimed in claim 3 wherein the connection mechanism comprises a screw mechanism to connect together two modules.

6. The device as claimed in 3, wherein at least one mating portion of each module comprises a seal.

7. The device as claimed in claim 6 wherein the seal comprises a non-permeable membrane layer.

8. The device as claimed in claim 6 wherein the seal is formed of a permeable or semi-permeable material that filters the output from a module that is being input into an adjacent module.

9. The device as claimed in claim 6, wherein the mating portion of each module comprises a cutting mechanism for breaking the seal of an adjacent module.

10. The device as claimed in claim 9 wherein the cutting mechanism comprises any one or more of: a sharp edge, a sharp tooth, multiple sharp teeth, a serrated edge, a piercing element, a piercing and cutting element, a slicing element, and a scoring element.

11. The device as claimed in claim 9 wherein the cutting mechanism is part of the connection mechanism.

12. The device as claimed in claim 9, wherein the cutting mechanism is activated by rotating one module relative to an adjacent module.

13. The device as claimed in claim 12 wherein the cutting mechanism is activated after the biological process performed by a module is complete.

14. The device as claimed in claim 3 further comprising a lid couplable to a mating portion of a module.

15. The device as claimed in claim 14 wherein the lid comprises a plunger arm and a plunger base.

16. The device as claimed in claim 14 wherein the lid comprises an opening for receiving a plunger arm of a plunger.

17. The device as claimed in claim 14 wherein the lid comprises a cutting mechanism for breaking the seal of a module when the lid is coupled to a module.

18. The device as claimed in claim 17 wherein the cutting mechanism comprises any one or more of: a sharp edge, a sharp tooth, multiple sharp teeth, a serrated edge, a piercing element, a piercing and cutting element, a slicing element, and a scoring element.

19. The device as claimed in claim 1 wherein each module is used to perform any one of: sample stabilisation, sample storage, enrichment, selective enrichment, filtration, centrifugation, DNA extraction lysis, DNA extraction washing, aerobic or anaerobic enrichment/culturing, chromatography, buffer exchange, mammalian cell culturing, phage isolation/enrichment, bacterial cell culturing, sample dilution, or processing environmental samples.

20. The device as claimed in claim 1 wherein a size of the device is compatible with laboratory equipment.
